(19) United States
(12) Patent Application Publication
(10) Pub. No.: US 2009/0038170 A1
(43) Pub. Date: Feb. 12, 2009

(54) Furniture And Picture Mounting Aid

(76) Inventor: Tung Feng Shyr, Rowland Heights, CA (US)

Correspondence Address: LAW OFFICES OF J.F. LEE, 17800 CASTLETON STREET, SUITE 383, CITY OF INDUSTRY, CA, 91748, US

(21) Appl. No.: 11/834,899

(22) Filed: Aug. 7, 2007

(51) Int. Cl. F16M 13/00

(52) U.S. Cl. 33/613; 248/544

(57) ABSTRACT

Finding the exact point of nail/screw insertion for mounting furniture or hanging pictures is not as easy as simply pounding in the nail or screwing in the screw. Present mounting aid provides a versatile device that can be easily attached to the cord, the sawtooth, or any apparatus at the back of furniture/picture, so that marking a desired point becomes easy and straightforward, without the effort of measuring size and calculating the mid point between two edges and oftentimes still resulting in pictures looking tilted or crooked.

### FIELD AND BACKGROUND OF PRESENT INVENTION

Hanging pictures and/or furniture pieces on the wall is a common task, yet the process of hanging a picture on a wall can be really frustrating. Several available means are used today to support the object upon a nail, screw or hook that is fastened to the wall. For example, several prior art means of supporting such an object include a wire (or cord) which is strung across the back of a frame of the object, hanging hardware specifically designed for the task, such as a sawtooth or triangle hanger, or a D-ring attached to the back of the object.

The back of the object is usually out of sight when placing the picture on the wall is considered. What really happens is that people will use their precise skill of “eyeing” the selected point and holding the object in the approximately desired spot and declared “good enough”, before proceeding to pound in the nail/hook, or drill in the screw.

Multiple unwanted holes in the wall are sometimes left on the wall; some of them not covered by the object when finally being hung up.

Present invention provides an easy way to mark the exact point for inserting or pounding in nail/screw.

Although there are some mounting aids available, these are mostly limited to only one type of hanging apparatus, such as the cord-based type, or the sawtooth type.

A recent application, by William Ryan Groepper, number 20060196069 seems to provide a universal solution; however, it, among others, requires a wire adapter for its “universality”.

Other gadgets professed to solve the problems of adaptability to all kinds of hanging apparatus, yet these other gadgets themselves create yet another layer of complexity that users need to deal with, since they are most suited for a certain type of apparatus (such as the sawtooth bracket) and then requires “adaptors” for attaching to other apparatus (such as a D-ring apparatus).

### OBJECT AND SUMMARY OF THE PRESENT INVENTION

Conventional picture/furniture hanging devices come in all shapes. While there is no telling which one is better than others in different usages, the difference itself, poses a problems for consumers when faced with the need to set a point for pounding in the nail or screwing in a hanging screw.

Identifying such a point is not rocket science and most people have no problem putting up a picture. However, more often than not, due to the difference in the apparatus, the pictures or furniture pieces being hung up would look crooked, tilting to one side, simply because the exact location is not selected properly.

A main object of the present invention, therefore, is to provide easy and flexible mounting aid for all kinds of hanging structure, whether it's cord-based, sawtooth bracket, or other types, that allow easy pinpointing of exact location for pounding in nails or screws.

A further object of present invention is to allow the easy of locating precise point for nail/screw/hook insertion, so that a gentle tap will mark the point, instead of some other means that require excessive force to press into the wall, as well as the back of the object piece to be hung, resulting in concern that there could be some dent or rupture done to the object piece or the wall.

### BRIEF DESCRIPTION OF THE DRAWINGS

FIG. 1 is a cut-profile view of various components pursuant to present disclosure.

FIG. 2a and FIG. 2b shows the perspective view of a cylindrical piece.

FIG. 3a and FIG. 3b shows the perspective view of a cap piece.

FIG. 4 shows the perspective view of an extension tube piece.

### DETAILED DESCRIPTION OF THE EMBODIMENT

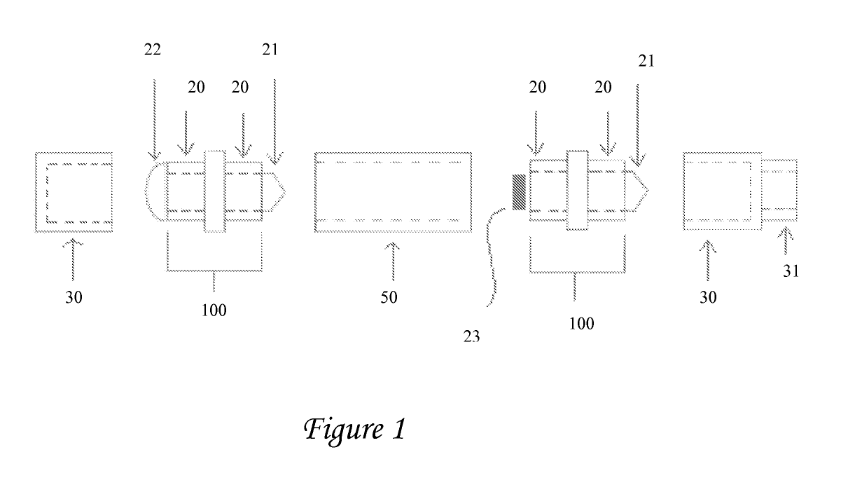

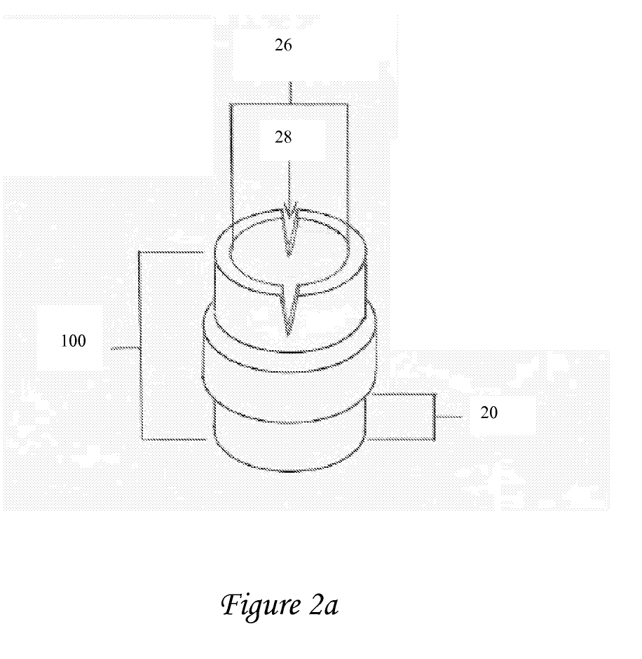

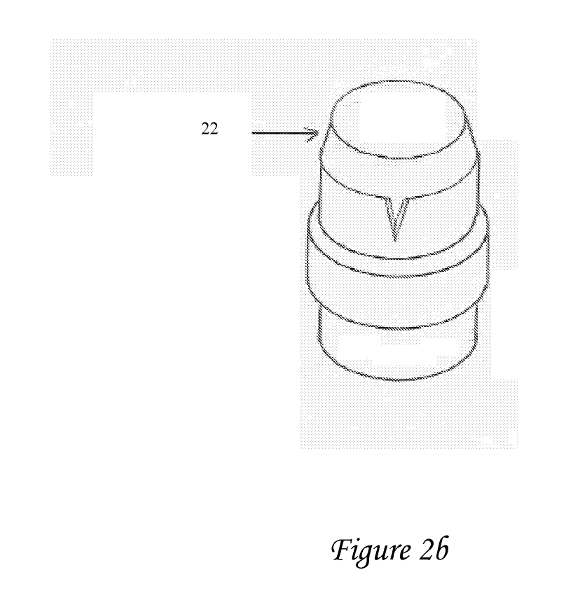

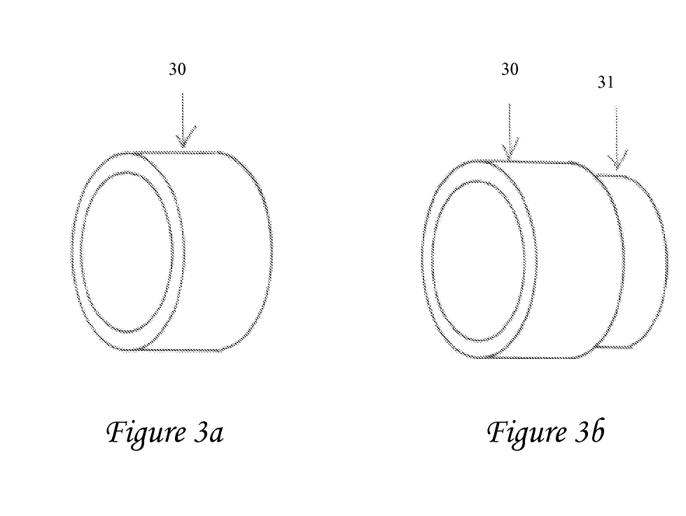

Referring to FIG. 1, FIG. 2a and FIG. 2b, a first cylindrical piece 100 is shown, as the basic building block of the furniture mounting aid.

At both ends of first cylindrical piece 100, there are reduced-diameter portions 20. The two reduced-diameter portions 20 have inside space 26 as defined by its circular wall, as shown in FIGS. 2a and 2b.

A marking tip device 21 can be fitted into the inside space 26, serving the purpose of marking a point for nail or screw on the wall of a room

On the inside space 26 of the other end on first cylindrical piece 100, some jell-like material or putty 22 can be fitted in, serving as temporary attachment between present hanging aid and the cord or the sawtooth piece on the back of a picture.

Alternatively, on the inside space 26, a magnet 23 sized to fit snuggly in to said space 26 can be used for temporary attachment between present hanging aid and the sawtooth or other metal piece on the back of a picture.

A couple of grooves 28 is formed on the circular wall of the reduced-diameter portion 20, so that the grooves 28 are located diametrically to each other, providing a “wedging in” tapered room for cord/wire to sink in, when positioning the mounting aid of present invention to the back of a furniture piece to be hung up.

A cap piece 30 is sized to fit over the reduced-portion 20 of cylindrical piece 100, so that it covers up and prevents the drying up of said marking tip 21, if said marking tip is of some ink-based instrument. Cap piece 30 also prevents marking tip 21, whether ink-based or chalk-based, from accidental marking of nearby objects when not in use.

A variation of cap piece 30 contains a protrusion part 31 that has a outer diameter equal to the portion 20, so that multiple cap pieces 30 can be stacked together and that extension tube 50 (explained below) can be connected to said protrusion part 31.

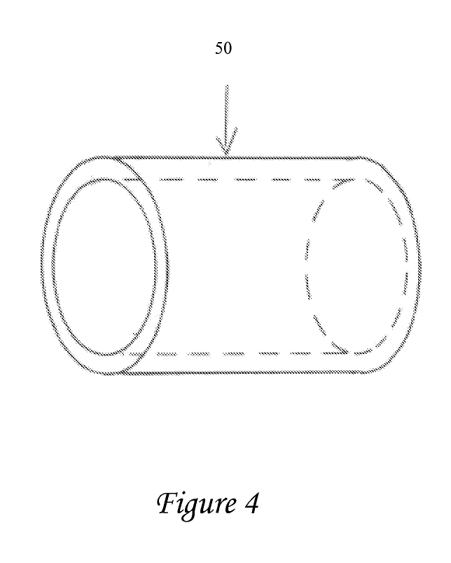

An extension tube 50 is shown in FIG. 4. Extension tube 50 is sized to fit over the reduced-portion 20 of cylindrical piece 100. That way, the distance between point of attachment to furniture piece (either cord-based or sawtooth, or others) to the desired point of marking for nail/screw insertion to the wall can be extended, if the furniture piece to be hung up contains concave inlet or chamber for present mounting aid to be affixed upon.

The use of putty material 22 allows for easy attaching to the apparatus at the back of an object piece. Depending on user preference, wire/cord can be sunk into the putty material 22 and further into groove 28. Or, a user can simply stick the mounting aid of present invention to the back of a furniture piece, with the wire/cord, or sawtooth, or other connecting device closely abutting the circular wall of the reduced-diameter portion 20.

If putty dries up, consumers can simply obtain more of same from hardware stores.

The marking tip 21 can be any kind, ink-based or chalk, as long as it is pre-processed to size it properly to fit into the inside space.

What is claimed is:

1. Furniture and picture mounting aid, comprising:
A first cylindrical piece having reduced diameter portion on both ends, with one end containing a marking tip and the other end containing adhesive material; and,
A cap piece sized to fit the outside of reduced diameter at either end of said first cylindrical piece.

2. The mounting aid of claim 1, wherein a couple of grooves are diametrically formed on the wall of said reduced diameter portion, resulting in a tapered-in opening for cord or wire type connecting apparatus.

3. The mounting aid of claim 1, wherein the adhesive material is jell-like putty material.

4. The mounting aid of claim 1, wherein the adhesive material is a magnet wedged inside the inside circular space as defined by the first cylindrical portion with reduced diameter.

5. The mounting aid of claim 1, wherein said cap piece contains a protrusion part that has an outer diameter equal to the outside of reduced diameter portion of said first cylindrical piece.

6. The mounting aid of claim 1, further comprising an extension tube sized to fit the reduced diameter portion of said first cylindrical piece, so that two of said first cylindrical pieces may be connected to reach longer indentation room.
